(19) United States
(12) Patent Application Publication
(10) Pub. No.: US 2012/0266472 A1
(43) Pub. Date: Oct. 25, 2012

(54) Tile Cutting Measurement Tool

(76) Inventor: Jorge Liza, Miami, FL (US)

(21) Appl. No.: 13/091,182

(22) Filed: Apr. 21, 2011

(51) Int. Cl. G01B 1/00

(52) U.S. Cl. 33/527

(57) ABSTRACT

A tile cutting measurement tool used to measure tiles, marbles, and the like. The tile cutting measurement tool is easily maneuverable, easily transportable, inexpensive to manufacture, and lightweight. The tile cutting measurement tool comprises of a contour gauge and a contour gauge guide that is connected to the contour gauge.

### BACKGROUND

The present invention relates generally to tile cutting measurement devices used in the industry of laying tiles, marbles, and the like. The invention relates to devices that are used to measure and cut floor tiles, marbles, and the like prior to installation.

The process of tile installation requires great deal of time, patience, labor, and accuracy. Most tile installation professionals in the industry are faced with cumbersome tile measuring and tile cutting issues prior to installation. Many of said issues can be resolved only through countless trial and error runs by the tile installation professional. The trial and error technique by a tile installation professional enormously delays the measurement process to cut tiles. Furthermore, it creates an economic burden on the productivity of a tile installation professional because of additional time, cost and labor required to get the tile installation process completed.

The process of tile measuring for cutting tiles also involves intricate angles and minute measurements which cannot be conveniently deciphered. The intricate process is rather tough, time consuming and frustrating for most, tile installation professionals. A flexible tile measuring tool is highly needed and required in the industry. A tile measuring tool that would assist tile installation professionals to accurately measure tiles for cutting process by overcoming difficult angles, make out minute measurements for any sized tiles and manage to complete the tile cutting and tile installation process within a reasonable time would be a tremendous asset within the industry.

As research suggests, there is no tool in the market that allows a tile installation professional to obtain a precise measurement for cutting tiles. There is also no tool out in the market that allows a tile installation professional to cut tiles of any size with any flexibility.

U.S. Pat. No. 7,020,973, Knight, U.S. Pat. No. 5,617,642, Marios, U.S. Pat. No. 1,141,640, Huguenin, and U.S. Pat. No. 923,875, McDonald are some of the existing prior arts that disclose a tile measuring tool for tile cutting and tile installation

For the foregoing reasons, there is a need for a tile cutting measurement tool that could be used to for tile cutting and tile installation processes with ease and efficiency. The tile measuring tool should be easily maneuverable, easily transportable, inexpensive to manufacture, and lightweight.

### SUMMARY

The present invention is directed to a tile cutting measurement tool that is used to measure tiles, marbles, and the like. The tile cutting measurement tool is easily maneuverable, easily transportable, inexpensive to manufacture, and lightweight.

The tile cutting measurement tool having the present invention comprises of a contour gauge and a contour gauge guide that is connected to the contour gauge. The contour gauge comprises of a three dimensional rectangular housing, a plurality of rectangular plate structures that are mounted within the rectangular plate structures, a plurality of guide pins, each guide pin shall be inserted within the central aperture of the three dimensional rectangular housing and through each rectangular plate structure, and a locking mechanism housed within the three dimensional rectangular housing. The contour gauge guide comprises of a pair of antennas, each antenna connects perpendicularly to the three dimensional rectangular housing. The contour gauge guide further comprises of a three dimensional rectangular block, each antenna connects to the rectangular block, a first plate, a second plate, a U-shaped plate, an independently standing screw and an independently standing nut. The independently standing screw and the independent nut secure the contour gauge guide in the following order: first, inserting the screw through the U-shaped plate; then, inserting the screw through the second plate; next, inserting the screw through the first plate; and lastly, securing the screw with the nut.

In an embodiment of the present invention the tile cutting measurement tool further comprises of at least one ruler mounted on the three dimensional rectangular housing.

In another embodiment of the present invention, the locking mechanism shall be a spring loaded locking mechanism or any other mechanism used to secure an antenna of the contour gauge guide.

In yet another embodiment of the present invention, the tile cutting measurement tool further comprises of a collapsible guide attached to the three dimensional rectangular housing via the collapsible guide receiving apertures. The collapsible guide is used to realign the plurality of rectangular plate structures of the present invention after taking a measurement of the environment measured.

An object of the present invention is to provide tile measurement cutting tool for a tile installation professional to use with ease, consistency and accuracy.

Another object of the present invention is to allow a tile installation professional to save money and time on tile installation process by reducing overall installation time and thus, reducing the labor hours and the associated costs to get the tile installation process completed efficiently.

Another object of the present invention is to allow a tile installation professional to have an accurate tile measuring tool that ensures its potential users to decipher precise measurements of intricate angles and minute dimensions.

Yet another object of the present invention is to allow a tile installation professional to measure a more wide range of tile sizes and not be confined to any particular tile size limitations.

Yet another object of the present invention is to allow a tile installation professional to visualize a mold or a template of any type of tile measurement before the tile is actually cut for installation purposes.

Another object of the present invention is to allow a tile installation professional to replace the use of one-meter measurement considerably by reducing cutting time, and thus, increasing greater profitability at work.

Another object of the present invention is to allow a tile installation professional to obtain without much effort, a cutting outline of the X-axis and Y-axis of a tile which cannot be done with products currently in the market.

Further object of the present invention is to provide a tile cutting measurement tool that is inexpensive to manufacture.

### DRAWINGS

These and other features, aspects, and advantages of the present invention will become better understood with regard to the following description, appended claims, and drawings where:

FIG. 1 is a top plan, perspective view of the present invention;

FIG. 2 is a bottom plan, oblique view of the independently standing screw, the U-shaped plate, second plate, the first plate, the U-shaped plate, and the independently standing nut of the present invention;

FIG. 3 is a front plan, oblique view of the plurality of rectangular plates structures, the three dimensional rectangular housing, the plurality of channels, at least one ruler and plurality of apertures of the present invention;

FIG. 4 is a front and left plan, oblique view of the three dimensional rectangular housing, one of the plurality of rectangular plates, at least one of the collapsible guides, at least one of the collapsible guide apertures, at least one of the channels, at least one of the rulers, at least one of the guide pins of the present invention;

FIG. 5 is a front plan perspective view of the invention without the contour gauge guide being used on a smaller sized tile, marble, or the like;

FIG. 6 is a front plan perspective view of the present invention in its entirety being used on a larger sized tile, marble, or the like;

FIG. 7 is a rear plan, oblique view of the three dimensional rectangular housing, the plurality of rectangular plate structures, the plurality of channels; at least one of the rulers, the two rear locking apertures, and the pair of collapsible guide receiving apertures of the present invention;

FIG. 8-8 is a partial sectional view of the locking mechanism that is housed inside the three dimensional rectangular housing of the present invention;

FIG. 8A is a sectional view of FIG. 8-8 that shows the locking mechanism in locked position of the present invention; and

FIG. 8B is a sectional view of FIG. 8-8 that shows the locking mechanism in unlocked position of the present invention.

### DESCRIPTION

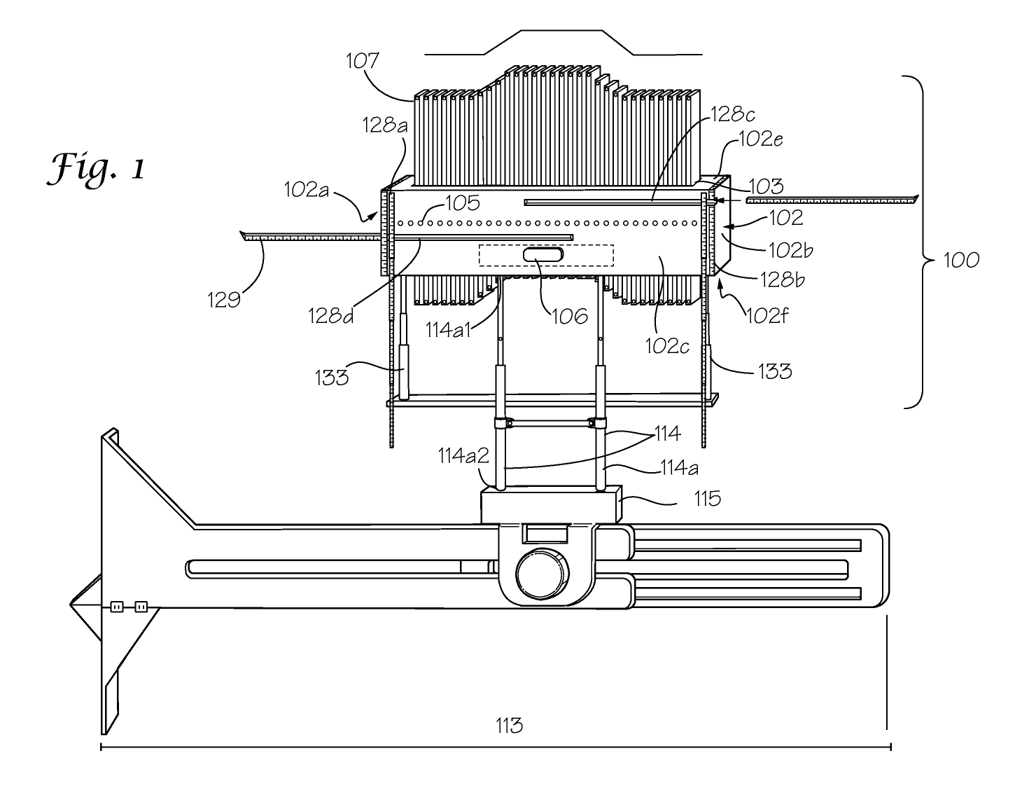

With reference to FIGS. 1-8b, the tile cutting measurement tool of the present invention is comprised of a contour gauge that is connected to a contour gauge guide.

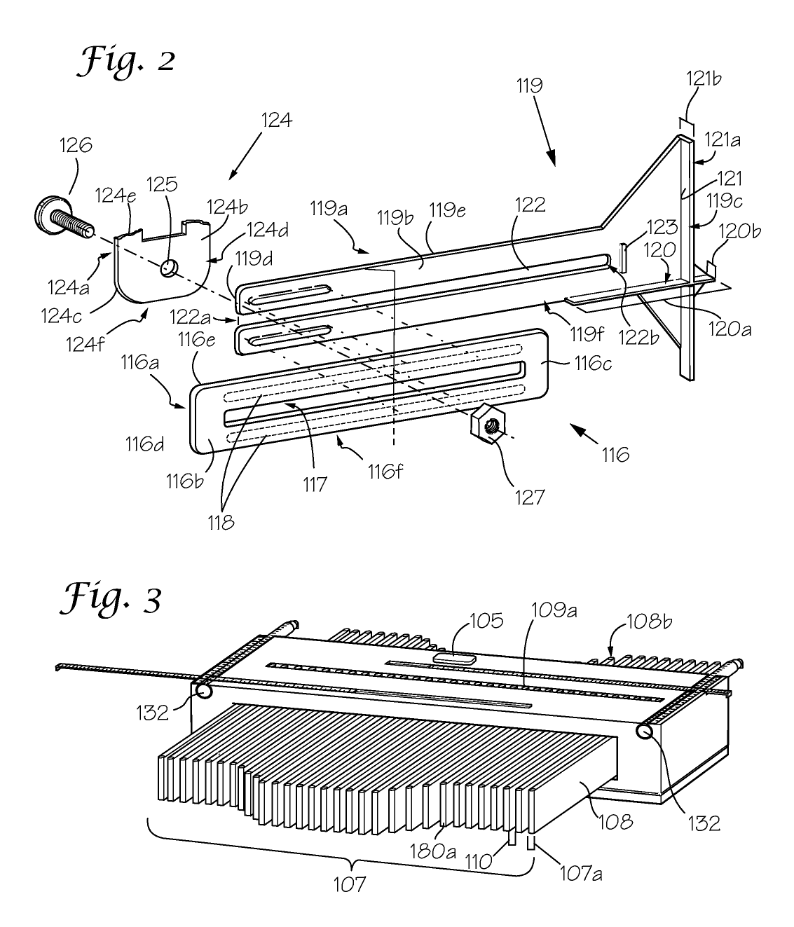

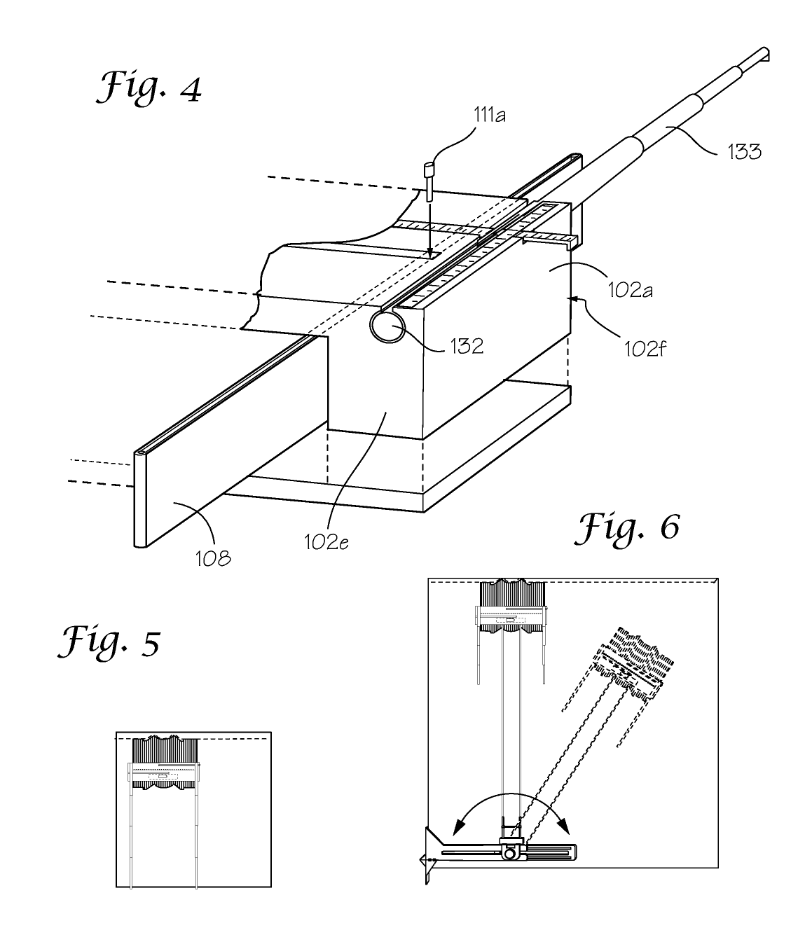

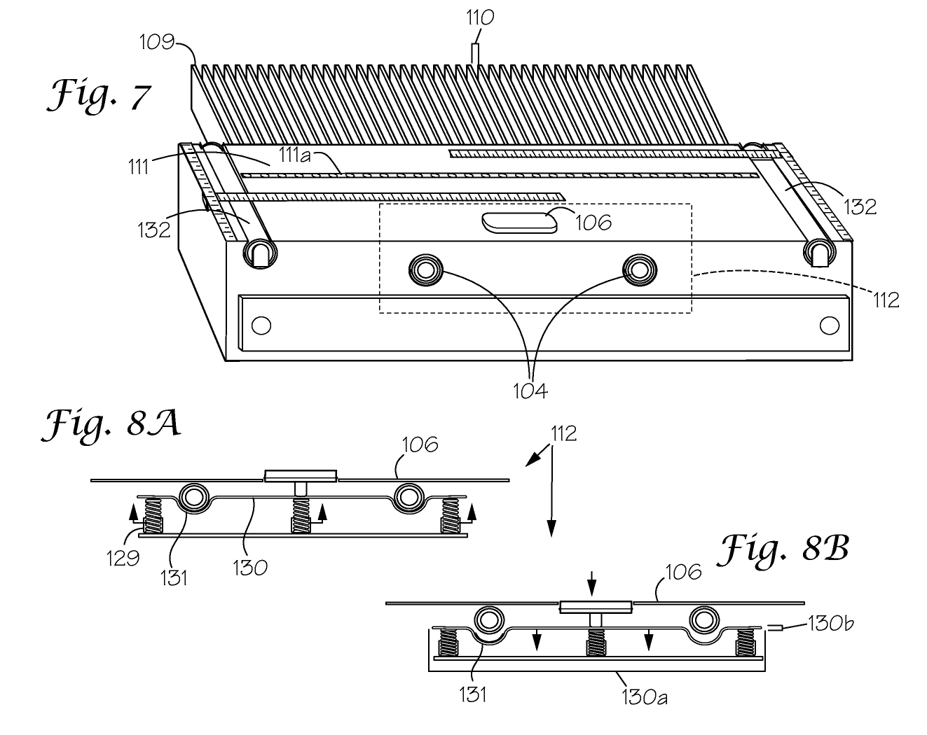

A contour gauge 100, comprises of a three dimensional rectangular housing 102, the three dimensional rectangular housing having a left 102a, a right 102b, a top 102c, a bottom 102d, a front 102e, and a rear side 102f. The front 102e and rear sides 102f define a guide aperture 103 that runs lengthwise throughout the front side 102e and the rear side 102f and each guide aperture 103 is parallel to each other. The rear side 102f of the three dimensional rectangular housing 102 further defines two rear locking apertures 104 as seen in FIG. 7, centered between the top side 102c of the three dimensional rectangular housing 102 and each guide aperture 103, the two rear locking apertures 104 being centrally located between the left 102a and right 102b sides of the three dimensional rectangular housing 102. The top side 102c, defines a central aperture 105 that runs lengthwise throughout the top side 102c and from the left 102a to the right side 102b of the three dimensional rectangular housing 102. The top side 102c further defines a top locking aperture 106, the top locking aperture 106 being positioned between the left 102a and right 102b sides of the three dimensional rectangular housing 102 and further between the rear side 102f of the three dimensional rectangular housing 102 and the central aperture 105 as seen in FIG. 1 and in FIG. 7. A plurality of rectangular plate structures 107 as seen in FIG. 1 and in FIG. 3, are slidingly mounted within the front 102e and rear 102f of the guide aperture 103. The rectangular plate structures 107 comprise of a pair of rectangular plates 107a as seen in FIG. 3, in which each rectangular plate structure 108 is parallel to each other and has a first 108a and second 108b end as seen in FIG. 3. The rectangular plate structures 107 further comprise of a pair of plate separators 109. The rectangular plates are connected to each other at their first 108a and second 108b ends by each plate separator 109a, thereby defining an internal guide space 110 as seen in FIG. 3 and in FIG. 7. Furthermore, there are a plurality of guide pins 111, in which each guide pin 111a shall be inserted within the central aperture 105 of the three dimensional rectangular housing 102 and through each internal guide space 110 of each rectangular plate structure 108 as seen in FIG. 4 and in FIG. 7. A locking mechanism 112 is housed within the three dimensional rectangular housing 102 as seen in FIG. 7, FIG. 8A and FIG. 8B.

A contour gauge guide 113 as seen in FIG. 1, comprises of a pair of antennas 114 as seen in FIG. 1, in which each antenna 114a parallel to each other at a sufficient distance within the pair 114 and has a first 114a1 and a second end 114a2, the first end 114a1 of the antenna 114a is connected perpendicularly to each of the two rear locking apertures 104 of the three dimensional rectangular housing 102. A three dimensional rectangular block 115 is connected to the second end 114a2 of each antenna 114a as seen in FIG. 1. The rectangular block 115 consists of a top 115a, a bottom 115b, a left 115c, a right 115d, a front 115e, and a rear end 115f, and the second end 114a2 of each antenna 114a is connected to the top end 115a of the rectangular block 115. The contour gauge guide further comprises of a first plate 116 as seen in FIG. 2. The first plate 116 having a top 116a, a bottom 116b, a left 116c, a right 116d, a front 116e, and a rear 116f side as seen in FIG. 2. The top 116a and the bottom 116b side define a close-ended centrally located aperture 117 that runs throughout the top 116a side and the bottom 116b side of the plate 116 lengthwise from right 116d side to the left side 116c of the plate 116 as seen in FIG. 2. The top 116a side and the bottom 116b side further define two parallel, close ended apertures 118 that run lengthwise from the right 116d side to the left 116c side of the first plate 116 and are positioned at a sufficient distance to make each of the two close-ended apertures 118 parallel to the centrally located aperture 117 as seen in FIG. 2. Additionally, the contour gauge guide 113 comprises of a second plate 119 as seen in FIG. 2. The second plate 119 has a top 119a, a bottom 119b, a left 119c, a right 119d, a front 119e and a rear 119f side. The bottom 119b side of the second plate 119 defines a shorter rectangular shaped ledge 120, the shorter rectangular shaped ledge having a length 120a side and a width 120b side, the length 120a side of the shorter rectangular shaped ledge 120 is parallel to the bottom 119b side of the plate 119 and the length 120a side of the shorter rectangular shaped ledge 120 is attached to the bottom 119b side of the second plate 119. The width 120b side of the shorter rectangular shaped ledge 120 is perpendicular to the bottom 119b side of the second plate 119 and extends out to the left 119c side of the second plate 119 on its length side 120a past the left 119c side of the second plate 119. The bottom 119c side further defines a longer second rectangular shaped ledge 121 as seen in FIG. 2. The longer second rectangular ledge 121 has a length 121a side and a width 121b side, the length 121a side of the second rectangular shaped ledge 121 is attached to the bottom 119b side of the second plate 119 and runs perpendicular to the bottom 119b side of the second plate 119. The width 121b of the longer second rectangular shaped ledge 121 is parallel to the bottom 119b side of the second plate 119. The length 121a side of the longer second rectangular shaped ledge 121 crosses through the width 120b side of the shorter rectangular shaped ledge 120 at a sufficient distance forming a cross shape on the bottom 119b side of the second plate 119 as seen in FIG. 2. Moreover, the top 119a side and the bottom 119b side of the second plate 119 defines a centrally located aperture 122 which is open ended on its right end 122a and close ended on its left end 122b as seen in FIG. 2. Additionally, the bottom 119b side of the second plate 119 further defines a rectangular shaped object 123 which is located closer to the left 119c side on the second plate 119 as seen in FIG. 2. Finally, the contour gauge guide 113 comprises of a U-shaped plate 124 having a top 124a, a bottom 124b, a front 124c, and a rear 124d side as seen in FIG. 2. The top 124a side and the bottom 124b side define a centrally located circular aperture 125, the top 124a side defines an independently standing screw 126 and an independently standing nut 127, the independently standing screw 126 penetrating through the centrally located circular aperture 125 from the top 124a side of the U-shaped plate 124 and the independently standing nut 127 secured on the independently standing screw 126 from the rear 116b side of the first plate 116 as seen in FIG. 2. The front 124c side of the U-shaped plate 124 is securely attached to the rear 115f end of the three dimensional rectangular block 115 as seen in FIG. 1.

The top 102c side of the three dimensional rectangular housing 102 further defines a left 128a and a right 128b channel that are adjacent to the left 102a and right 102b sides of the three dimensional rectangular housing 102 respectively, and a front 128c and a rear 128d channel that are adjacent to the front 102e and the rear 102f side of the three dimensional rectangular housing 102 respectively as seen in FIG. 1. The tile cutting measuring tool further comprises of at least one ruler 129 slidingly housed within at least one channel (128a, 128b, 128c or 128d) as seen in FIG. 1.

The locking mechanism 112 of the tile cutting measuring tool comprises of at least one spring 129, at least one thin metal rod 130 with a length 130a side, width 130b side as seen in FIG. 8A and FIG. 8B. The length 130a side of the thin metal rod 130 contains at least one grip 131 as seen in FIG. 8A and FIG. 8B. Each grip 131 is located symmetrically on the length 130a side of the thin metal rod 130 as seen in FIG. 8A and FIG. 8B. Each grip also accommodates each of the two rear locking apertures 104, all housed within the locking mechanism 112 of the three dimensional rectangular housing 102 as seen in FIG. 7. FIG. 8A, and FIG. 8B.

The front 102e and the rear 102f side of the three dimensional rectangular housing 102 further defines a pair of collapsible guide receiving apertures 132 as seen in FIG. 3, FIG. 4 and FIG. 7. The collapsible guide receiving apertures 132 are parallel to each other and adjacent to the left 102a and the right 102b side of the three dimensional rectangular housing 102 as seen in FIG. 1, FIG. 4 and FIG. 7. The tile cutting measuring tool further comprises of a pair of collapsible guides 133 as seen in FIG. 1 and in FIG. 4. The pair of collapsible guides 133 is attached to the rear 102f side of the three dimensional rectangular housing 102 via the collapsible guide receiving apertures 132 as seen in FIG. 1 and FIG. 4.

An advantage of the present invention is that is provides tile measurement cutting tool for a tile installation professional to use with ease, consistency and accuracy.

Another advantage of the present invention is that it allows a tile installation professional to save money and time on tile installation process by reducing overall installation time and thus, reducing the labor hours and the associated costs to get the tile installation process completed efficiently.

Another advantage of the present invention is that it allows a tile installation professional to have an accurate tile measuring tool that ensures its potential users to decipher precise measurements of intricate angles and minute dimensions.

Yet another advantage of the present invention is that it allows a tile installation professional to measure a more wide range of tile sizes and not be confined to any particular tile size limitations.

Yet another advantage of the present invention is that it allows a tile installation professional to visualize a mold or a template of any type of tile measurement before the tile is actually cut for installation purposes.

Another advantage of the present invention is that it allows a tile installation professional to replace the use of one-meter measurement considerably by reducing cutting time, and thus, increasing greater profitability at work.

Another advantage of the present invention is that it allows a tile installation professional to obtain without much effort, a cutting outline of the X-axis and Y-axis of a tile which cannot be done with products currently in the market.

Further advantage of the present invention is that it provides a tile cutting measurement tool that is inexpensive to manufacture.

Although the present invention has been described in considerable detail in reference to certain preferred versions thereof, other versions are possible. Therefore, the spirit and scope of the claims should not be limited to the description of the preferred versions contained herein.

What is claimed is:

1. A tile cutting measuring tool, the tile cutting measure tool comprises:
a contour gauge, the contour gauge comprising:
a three dimensional rectangular housing, the three dimensional rectangular housing having a length, a width, a height, a left, a right, a top, a bottom, a front, and a rear side:
the front and rear sides define a guide aperture that runs lengthwise throughout the front side and the rear side and each guide aperture is parallel to each other, the rear side of the rectangular housing further defines two rear locking apertures centered between the top side of the rectangular housing and each guide aperture, the locking apertures being centrally between the left and right sides of the rectangular housing; and
the top side, defines a central aperture that runs throughout the length of the top side and from the left to the right side of the rectangular housing, the top further defines a top locking aperture, the top locking aperture being positioned between the left and right sides of the rectangular housing and further between the rear side of the rectangular housing and the central aperture;
a plurality of rectangular plate structures that are slidingly mounted within the front and rear apertures, the rectangular plate structures comprising:
a pair of rectangular plates, each rectangular plate is parallel to each other and has a first and second end; and
a pair of plate separators, the rectangular plates are connected to each other at their first and second ends by each plate separator, thereby defining an internal guide space;
a plurality of guide pins, each guide pin shall be inserted within the central aperture of the three dimensional rectangular housing and through each internal guide space of each rectangular plate structure; and
a locking mechanism, the locking mechanism housed within the three dimensional rectangular housing; and
a contour gauge guide, the contour gauge guide comprising:
a pair of antennas, each antenna parallel to each other at a particular distance within the pair and has a first and a second end, the first end of the antenna is connected perpendicularly to each of the two rear locking aperture of the three dimensional rectangular housing;
a three dimensional rectangular block connected to the second end of each antenna, the rectangular block consists of a top, a bottom, a left, a right, a front, and a rear end, and the second end of each antenna is connected to the top end of the rectangular block;
a first plate, the first plate having a top, a bottom, a left, right, a front and a rear side:
the top and the bottom side define a centrally located aperture that runs throughout the top side and the bottom side of the plate at a certain defined length from right side to the left side of the plate, the centrally located aperture is close ended on both sides, the top side and the bottom side further define two parallel, close ended apertures that run lengthwise from the right side to the left side of the first plate and are positioned at a sufficient distance to make each of the two close ended apertures parallel to the centrally located aperture;
a second plate, the second plate having a top, a bottom, a left, right, a front and a rear side:
the bottom side of the second plate defines a shorter rectangular shaped ledge, the shorter rectangular shaped ledge having a length side and a width side, the length side of the shorter rectangular shaped ledge is parallel to the bottom side of the plate and the length side of the shorter rectangular shaped ledge is attached to the bottom side of the second plate and runs parallel with the bottom side of the plate, the width side of the shorter rectangular shaped ledge is perpendicular to the bottom side of the second plate and extends out to the left side of the second plate on its one end, the bottom side further defines a longer second rectangular shaped ledge, the longer second rectangular ledge has a length side and a width side, the length side of the second rectangular shaped ledge is attached to the bottom side of the second plate and runs perpendicular to the bottom side of the second plate, the width of the second rectangular shaped ledge is parallel to the bottom side of the second plate, the length side of the longer second rectangular shaped ledge crosses through the width side of the shorter rectangular shaped ledge at a sufficient distance forming a cross shape on the bottom side of the second plate;
the top side and the bottom side of the second plate defines a centrally located aperture, the aperture is open ended on its one end and close ended on its other end;
the bottom side of the second plate further define a rectangular shaped object, the rectangular shaped object is located closer to the left side on the second plate; and
a U-shaped plate having a top, a bottom, a front, and a rear side, the top side and the bottom side define a centrally located circular aperture, the top side defines an independently standing screw and an independently standing nut, the independently standing screw penetrating through the centrally located circular aperture from the top side of the U-shaped plate and the independently standing nut secured on the independently standing screw from the rear side of the first plate, and the front end of the U-shaped plate is securely attached to the rear end of the three dimensional rectangular block.

2. The tile cutting measuring tool of claim 1, wherein the top side of the three dimensional rectangular housing further defines a left and a right channel that are adjacent to the left and right sides of the three dimensional rectangular housing respectively and a front and a rear channel that are adjacent to the front and the rear side of the rectangular housing respectively, and the tile cutting measuring tool further comprises:
At least one ruler slidingly housed within at least one channel.

3. The tile cutting measuring tool of claim 2, wherein the locking mechanism comprises:
at least one spring, at least one thin metal rod with a length side, width side, height side, and thickness side, the length side of the thin metal rod contains at least one grip, each grip located symmetrically on the length side of the thin metal rod, each grip also accommodates each of the two rear locking apertures, all housed within the locking mechanism of the three dimensional rectangular housing.

4. The tile cutting measuring tool of claim 3, wherein the front and the rear side of the three dimensional rectangular housing further defines a pair of collapsible guide receiving apertures parallel to each other and adjacent to the left and the right side of the three dimensional rectangular housing, the tile cutting measuring tool further comprises of a collapsible guide attached to the rear side of the three dimensional rectangular housing via the collapsible guide receiving apertures.
